(19) United States
(12) Patent Application Publication
(10) Pub. No.: US 2006/0017273 A1
(43) Pub. Date: Jan. 26, 2006

(54) Steering control handle bars

(76) Inventor: Gary R. Woerman, Beatrice, NE (US)

Correspondence Address: GARY R. WOERMAN, 417 N. 11TH STREET #1, BEATRICE, NE, 68310, US

(21) Appl. No.: 10/899,426

(22) Filed: Jul. 26, 2004

(51) Int. Cl. B62D 1/00

(52) U.S. Cl. 280/771

(57) ABSTRACT

A matched set of operator controlled handle bars incorporated into the steering control levers of a zero turn lawnmower or like controlled vehicle which gives the operator a means of controlling the steering and speed of the vehicle with one or both hands and when positioned above the steering control levers gives the operator greater leverage. The handle bars can be an integral part with the steering control levers or alternately can be an attachment to preexisting steering control levers. The attachment option for the handle bars provides a means for rotational adjustability of the handle bars around the circumference of the end of the steering control levers to suit the operators size and arm length.

### CROSS-REFERENCE TO RELATED APPLICATIONS

No copending non provisional applications known.

### STATEMENT REGARDING FEDERALLY SPONSORED RESEARCH DEVELOPMENT

Not applicable

### REFERENCE TO SEQUENCE LISTING, TABLE, OR COMPUTER PROGRAM LISTING

Not applicable

### BACKGROUND OF THE INVENTION

This invention is an unique operator controlled matched set of handle bars which are incorporated into the steering control levers of a zero turn lawnmower enhancing the operators ease of operation, comfort and leverage for steering control.

Left and right steering control levers have become the common method of controlling the steering on zero turn lawnmowers. Each steering control lever, depending on its forward position, independently controls the speed of rotation and the direction of rotation of a drive wheel. Together the left and right steering control levers can be used to move the lawnmower in a straight path direction forward or reverse at a range of speeds or make varying diameter left and right turns at a range of speeds. The operator accomplishes these vehicle motions by changing the relative forward position of the two levers. These steering control levers often have dampeners and springs to increase the required effort to move each lever when changing the wheel rotational speed or the wheel direction of rotation to give the controls better operator feel and control. These dampeners can cause lever forces which are too high for many operators and cause operator fatigue over time. The two steering control levers are moved laterally apart from each other when the vehicle is placed in the park condition and laterally together with their ends adjacent when in the vehicle operating position.

The two new handle bars connect onto the ends of the two existing steering control levers. Each handle bar has an elongated protrusion which extends radially outward from the end of each steering control lever. The two protrusions of the left and the right handle bars, attached to the left and the right steering control levers respectively, are adjacent and aligned to each other when in straight travel vehicle motion allowing both handle bars to be gripped together with one hand of the operator. Additional leverage is obtained by the operator when the protrusions are positioned above the ends of the steering control levers. All prior hand grip locations on the steering control levers remain available for use by the operator if desired. The additional hand grip position of the handle bars allows the operator to change his arm position reducing fatigue and repetative motion injuries. In addition the use of one hand to operate the vehicle frees up the other hand to do other functions of the machine or to drink a refreshment.

### BRIEF SUMMARY OF THE INVENTION

A matched set of steering control handle bars incorporated into the steering control levers of a zero turn lawnmower which gives the operator a means of making steering and speed changes with one or both hands and can give increased leverage to the operator for moving the motion control levers. The hand grip locations of the existing steering control levers are maintained.

### BRIEF DESCRIPTION OF SEVERAL VIEWS OF THE DRAWINGS

FIG. 1 is a rear view of one handle bar.

FIG. 2 is a rear view of the handle bars installed on the steering control levers.

FIG. 3 is a rear view of the handle bars continuous with the steering control levers.

### DETAILED DESCRIPTION OF THE INVENTION

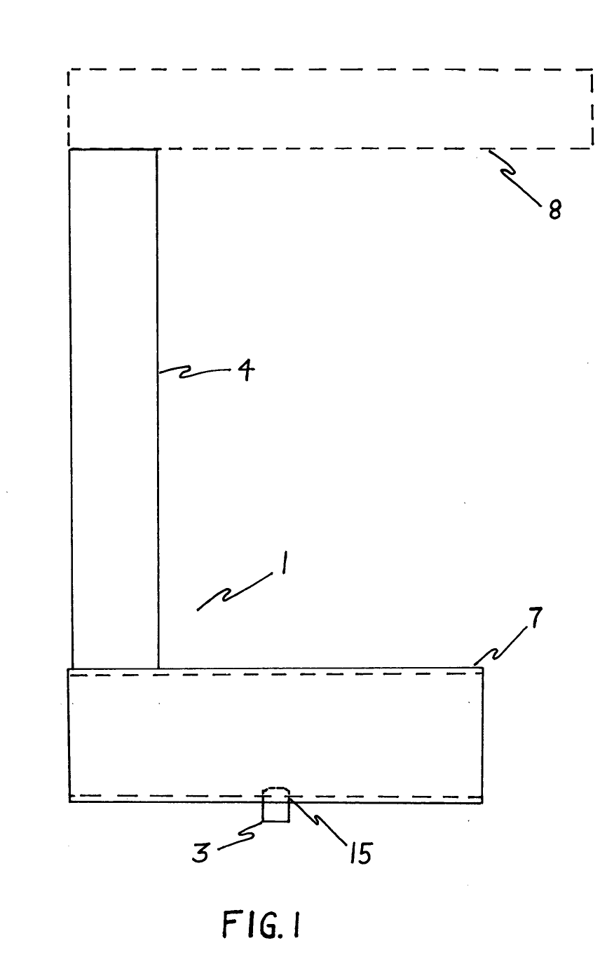

Referring to FIG. 1, the first handle bar 1 of two matched handle bars is shown with an elongated fastening tube 7 attached to an elongated first handle 4 and an optional elongated second handle 8 attached to first handle 4. A threaded set screw 3 extends through a threaded hole 15 in the tubing wall of fastening tube 7.

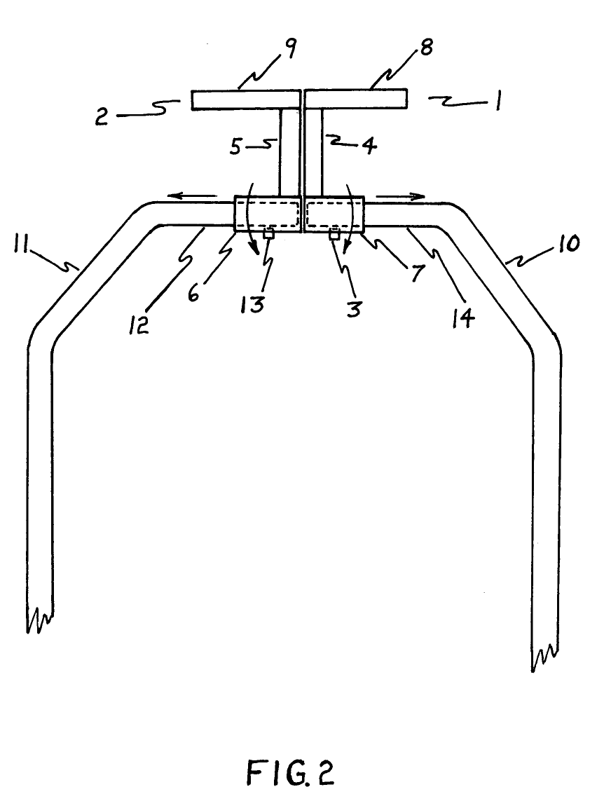

Referring to FIG. 2, the two steering control levers 10 and 11 for a zero turn lawnmower are shown in the operational position as viewed by the operator sitting behind said steering control levers 10 and 11. First handle bar 1 and second handle bar 2 are shown installed onto steering control levers 10 and 11 respectively. Elongated fastening tube 7 of first handle bar 1 is inserted onto ending straight protrusion 14 of steering control lever 10. Second handle bar 2 is shown installed onto ending straight protrusion 12 of steering control lever 11 in the same manner as first handle bar 1. Handle 4 of first handle bar 1 is shown disposed in a substantially adjacent parallel position to handle 5 of second handle bar 2. First handle bar 1 can be rotated about or moved laterally on ending straight protrusion 14 of steering control lever 10 to all possible positions around the circumference and length of ending straight protrusion 14. Set screw 3 can be tightened to hold the fastening tube 7 of first handle bar 1 onto ending straight protrusion 14 at an operator selectable position. In the same manner second handle bar 2 can be positioned and held on ending straight protrusion 12. The selected position of first and second handle bars 1 and 2 above the steering control levers 10 and 11 gives increased leverage to the operator when hand forces are applied to elongated handles 4 and 5 or optional elongated handles 8 and 9 when compared to hand forces applied to steering control levers 10 and 11 without handle bars 1 and 2. The handle bars 1 and 2 can be positioned with the elongated handles 4 and 5 directed in varying degrees forward or rearward to suit the operators arm length and most comfortable arm position. The elongated handles 4 and 5 can be gripped together with either the right or left hand for one hand movement forward and rearward of both steering control levers 10 and 11 to change vehicle speed. The palm of the right hand can be placed on elongated handle 4 and the thumb of that hand can be used to push the elongated handle 5 forward with respect to elongated handle 4 for right turns and similarly the fingers of the right hand can be used to push the elongated handle 5 rearward with respect to elongated handle 4 for left turns. The left hand can be used to steer and change speed of the vehicle in a similar manner mirroring the motions of the above described right hand. Consequently one hand operation by the operator can be used to steer left or right and change vehicle speed leaving the operators second hand available for other functions or a handicapped operator with the use of only one hand can operate the vehicle.

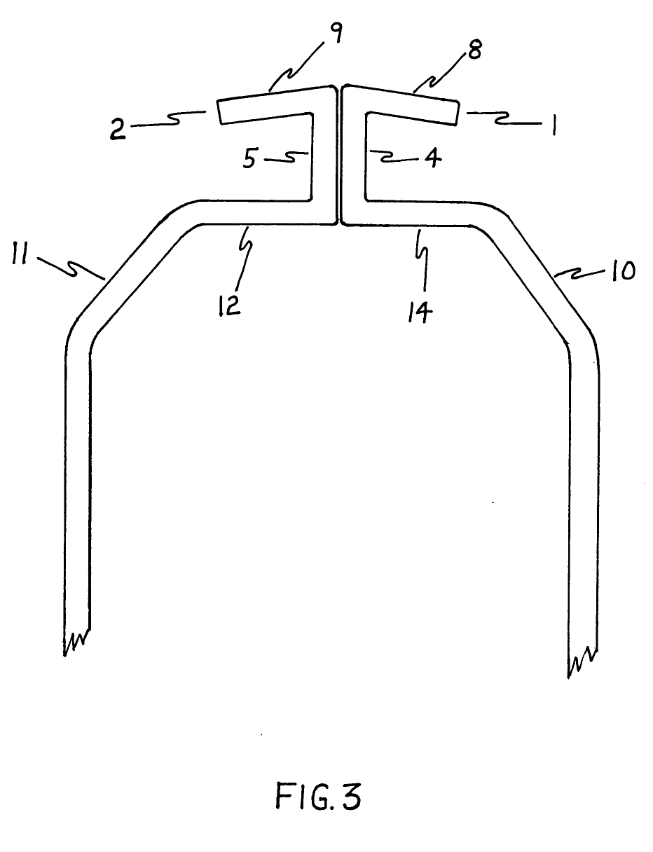

FIG. 3 indicates the two steering control levers 10 and 11 of a zero turn lawnmower with handle bars 1 and 2 formed as one continuous part in a permanent position extending from ending straight protrusions 14 and 12 respectively. Although the adjustability of the handle bars in FIG. 3 is compromised compared to the handle bars of FIG. 2, the design of FIG. 3 has a clean smooth appearance, has fewer parts and would likely be less costly to manufacture. It should be noted that other permanent positions of the handle bars 1 and 2 on the steering control levers 10 and 11 are possible in the same manner as the other possible adjustable positions of the handle bars on the steering control levers 10 and 11 of FIG. 2. It should be noted that the elongated optional handle 8 can be positioned either perpendicularly to handle 4 or at a disposed angle to handle 4 or be absent from handle 4. One possible disposed angle of optional handle 8 to handle 4 is indicated in FIG. 3. In general the greatest operator comfort occurs when optional handle 8 is disposed at an angle downward from handle 4 and forward from ending straight protrusion 14. Optional handle 9 can be positioned in the same way as described above for optional handle 4.

1. A hand moveable control means comprising matched first and second handle bars, the first handle bar having a mounting tube and an elongated handle extending outward from the mounting tube whereby said mounting tube is insertable onto the end of right steering control lever on a self propelled vehicle whereby the mounting tube is rotateable around the circumference of the right steering control lever or moveable laterally on the right steering control lever to an operator selectable position whereby the mounting tube has a fastening means operably connected thereto that can be activated by the operator to fix the position of the first handle bar and mounting tube therewith onto the right steering control lever, a matched second handle bar having like components as first handle bar whereby second handle bar can be fixed to left steering control lever in a position selectable by the operator making the elongated handle of the first handle bar and the elongated handle of the second handle bar to be in spaced substantial parallel adjacentcy when both steering control levers are aligned for straight travel path vehicle travel.

2. A hand moveable control means comprising matched first and second handle bars, the first handle bar having an elongated handle extending outward from the circumference at the left end of the right steering control lever whereby the directional transition of the end of the steering control lever to the elongated handle is a bend forming a continuous protrusion integrating the right steering control lever and the elongated handle of the first handle bar as one part, a matched second handle bar extending outward from the circumference at the right end of the left steering control lever whereby the directional transition of the end of the steering control lever to the elongated handle is a bend forming a continuous protrusion integrating the left steering control lever and the elongated handle of the second handle bar as one part, the relative position of the elongated handle of the first handle bar and the elongated handle of the second handle bar to be in spaced substantial parallel adjacentcy when both steering control levers are aligned for straight travel path vehicle travel.

3. The improvement of claim 1 whereby each of said elongated handles has a second elongated handle that extends outward from the circumference of said elongated handle at an angular position.

4. The improvement of claim 2 whereby the each said elongated handle has a second elongated handle that extends outward from the said elongated handle at an angular position forming a continuous protrusion with the said elongated handle and the directional transition from the said elongated handle to the second elongated handle is a bend.

5. The improvement of claim 1 whereby the fastening means is a set screw.

6. The improvement of claim 1 whereby the fastening means consists of a series of holes around the circumference of the mounting tube that lock onto a finger depressable outward spring biased button that is located on the outer surface of the steering control lever whereby button is sized to fit into the holes in the mounting tube thereby locking the handle bar to the steering control lever at predetermined locations.

7. The improvement of claim 1 whereby the said first and second handle bars are mirror images of each other.

8. The improvement of claim 1 whereby the said first and second handle bars are identical.

9. The improvement of claims 1 and 2 whereby the elongated handle has an elongated vertical protrusion which is extendable in an upward direction above the top of the elongated handle and retractable in a downward direction at or below the top of the elongated handle for use as a visual alignment sight by the operator for making straight rows.

10. The improvement of claims 1 and 2 whereby the handle bars are used on the steering control levers of a zero turn lawnmower.

11. The improvement of claim 1 and 2 whereby rubber hand grips are installed onto the handle bars.

12. The improvement of claim 1 whereby the mounting tube, said elongated handle and a second elongated handle which extends outward from the circumference of the said elongated handle are all metal tubes that are fastened to each other with welds.

13. The improvement of claim 1 whereby the said elongated handles each have substantially “D” shaped cross sections with a flat side whereby the flat sides of the two elongated handles are in spaced substantial parallel adjacentcy when both steering control levers are aligned for straight travel path vehicle travel.

14. The improvement of claim 2 whereby the steering control levers and handle bars are coated with a porous rubber or rubber like material for gripping with the hands.

15. The improvement of claims 1 and 2 whereby the said elongated handles are attached at an angle onto each of the mounting tubes.

16. The improvement of claim 1 and 2 whereby a second elongated handle extends outward from the circumference of said elongated handle and is substantially perpendicular to the said elongated handle on each handle bar.

17. The improvement of claim 1 whereby the handle bars are installed onto steering control levers that have a porous rubber or rubber like material on the surface of the steering control handles.

18. The improvement of claim 1 whereby the mounting tubes have chamfers on the inside diameter on one or both ends of the mounting tubes.
